(19) United States
(12) Patent Application Publication
(10) Pub. No.: US 2004/0179141 A1
(43) Pub. Date: Sep. 16, 2004

(54) Method, apparatus, and system for reducing cross-color distortion in a composite video signal decoder

(76) Inventor: Robert J. Topper, Hatboro, PA (US)

Correspondence Address: RATNERPRESTIA, P O BOX 980, VALLEY FORGE, PA, 19482-0980, US

(21) Appl. No.: 10/385,419

(22) Filed: Mar. 10, 2003

(51) Int. Cl. H04N 5/21

(52) U.S. Cl. 348/663; 348/624

(57) ABSTRACT

A method, apparatus, and system for reducing cross-color distortion in an image produced by a composite video signal decoder is disclosed. Cross-color distortion, which is due to high frequency luminance being passed through the chrominance signal, is reduced by processing chrominance phases (i.e., color information) associated with a reference pixel and pixels adjacent the reference pixel to derive a scaling factor for scaling the reference pixel. The reference pixel is attenuated by the scaling factor if none of the adjacent pixels have a chrominance phase that is similar to the reference pixel.

### FIELD OF THE INVENTION

The present invention relates to the field of consumer electronics and, more particularly, to methods, apparatus, and systems for reducing cross-color distortion in images produced by a composite video signal decoder.

### BACKGROUND OF THE INVENTION

In a color television (TV) system (such as NTSC), the luminance and chrominance components (“luma” and “chroma,” respectively) of a composite color video signal are disposed within the video frequency spectrum in a frequency-interleaved relation. Generally, the luma components are positioned at integral multiples of the horizontal line scanning frequency and the chroma components are positioned at odd multiples of one-half this frequency. In the NTSC system, the upper portion (i.e., about 2.1 to 4.2 MHz) of the video frequency spectrum (0 to 4.2 MHz) is shared by chroma components and high frequency luma components. The lower portion (below about 2.1 MHz) of the video frequency spectrum is occupied solely by luma components. The video frequency spectrum is located within a 6 MHz NTSC video channel and begins at 1.25 MHz within this channel. Thus, 2.1 MHz in the video frequency spectrum corresponds to 3.35 MHz in the 6 MHz NTSC video channel. Additionally, in accordance with the NTSC system, from horizontal-line to horizontal-line (“adjacent lines”), the luma components are in-phase with one another and the chroma components are 180 degrees out-of-phase with one another.

Comb filters are frequently used to separate the luma and chroma components from one another. Comb filters operate on the premise that the composite video signals of adjacent lines are highly correlated. Since the luma components of adjacent lines are in-phase and the chroma components are out-of-phase, adding the composite signal of a current line to the composite signal of a previous line yields the luma components for the current line. This effectively removes the chroma components, leaving only the luma components. Likewise, subtracting the composite signal of the previous line from the composite signal of the current line yields the chroma components for the current line. This effectively removes the luma components, leaving only the chroma components.

Imperfect cancellation of luma components (called “artifacts) in the chroma signal may produce “cross-color distortion” on a video display. Cross-color distortion is a condition in which erroneous colors are displayed on a video display, which, typically, are produced if diagonal high frequency luma is present. For example, as a referee moves across an Astroturf field during a sporting event, the referee's jersey, having closely spaced vertical black and white stripes, will appear to have a variety of other colors, e.g., red, yellow, and blue. The display of erroneous colors is distracting to the viewer of a program, thus diminishing the viewer's enjoyment of the program.

Accordingly, there is a need for methods, apparatus, and systems that compensate for luma artifacts in a chroma signal to reduce cross-color distortion. The present invention fulfills this need among others.

### SUMMARY

The present invention provides a method, apparatus, and system for selectively scaling a chroma signal containing luma artifacts to reduce cross-color distortion. The present invention satisfies the aforementioned needs by processing chroma phases (i.e., color information) associated with a reference chroma pixel and pixels adjacent the reference chroma pixel to derive a scaling factor for scaling the reference chroma pixel. The reference chroma pixel is scaled (e.g., attenuated) based on the scaling factor if none of the adjacent pixels have a chroma phase that is similar to the reference chroma pixel. Due to the bandwidth-limited nature of conventional video standards such as NTSC, accurate color information does not change substantially on a pixel-by-pixel basis. Therefore, if a chroma pixel having no adjacent pixel with a similar chroma phase is detected, the chroma pixel may include inaccurate color information due to luma artifacts being present in the chroma signal, also known as cross-color distortion. Attenuating these chroma pixels compensates for the inaccurate color information, thereby reducing cross-color distortion.

The method selectively scales a chroma signal containing luma artifacts to reduce cross-color distortion where the chroma signal is separated from a composite video signal. The method includes processing a reference chroma phase associated with a reference chroma pixel and at least two adjacent chroma phases associated with at least two other pixels adjacent the reference chroma pixel to derive a scaling value for the reference chroma pixel, the scaling value based on chroma phase differences between the reference chroma pixel and at least one adjacent pixel, and selectively scaling the reference chroma pixel based on the scaling value.

The apparatus processes a chroma signal containing luma artifacts to reduce cross-color distortion where the chroma signal is separated from a composite video signal. The apparatus includes a processor that processes a reference chroma phase associated with a reference chroma pixel and at least two adjacent chroma phases associated with each of at least two other pixels adjacent the reference chroma pixel to derive a scaling value for the reference chroma pixel, the scaling value based on chroma phase differences between the reference chroma pixel and at least one adjacent pixel, and a scaling circuit that selectively scales the reference chroma pixel by the scaling value.

The system selectively scales a chroma signal containing luma artifacts to reduce cross-color distortion where the chroma signal is separated from a composite video signal. The system includes means for processing a reference chroma phase associated with a reference chroma pixel and at least two adjacent chroma phases associated with at least two other pixels adjacent the reference chroma pixel to derive a scaling value for the reference chroma pixel, the scaling value based on chroma phase differences between the reference chroma pixel and at least one adjacent pixel, and means for selectively scaling the reference chroma pixel based on the scaling value.

### BRIEF DESCRIPTION OF THE DRAWINGS

The invention is best understood from the following detailed description when read in connection with the accompanying drawings. This emphasizes that according to common practice, the various features of the drawings are not drawn to scale. On the contrary, the dimensions of the various features are arbitrarily expanded or reduced for clarity. Included in the drawings are the following features:

FIG. 1 is a block diagram of a Y/C separation apparatus in accordance with the present invention;

FIG. 2A is a circuit diagram of an exemplary demodulator for use in the Y/C separation apparatus of FIG. 1;

FIG. 2B is a timing diagram for the demodulator of FIG. 2A;

FIG. 3 is a graphical representation of a chroma phase, α, produced by the Y/C separation apparatus of FIG. 1;

FIG. 4 is an illustrative representation of pixels being compared by the Y/C separation apparatus of FIG. 1; and

FIG. 5 is a block diagram of an artifact detector for use in one embodiment of the Y/C separation apparatus of FIG. 1.

### DETAILED DESCRIPTION OF THE INVENTION

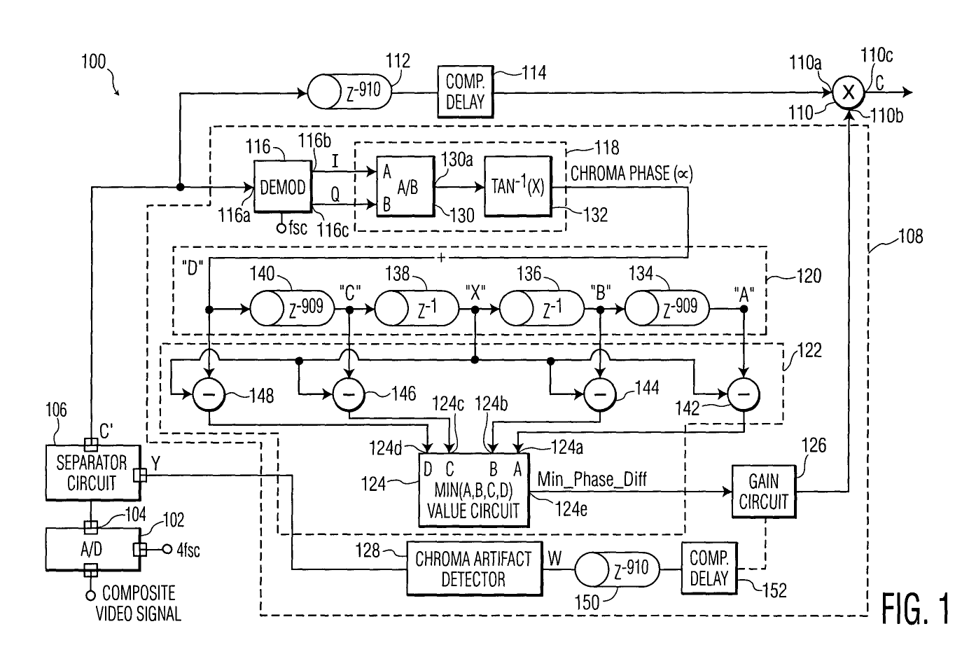

FIG. 1 depicts a luminance/chrominance (Y/C) separation apparatus 100 for separating a composite video signal into a chroma signal (C) and a luma signal (Y) in accordance with one embodiment of the present invention. The composite video signal is received from the output port of a video detector stage (not shown).

The composite video signal is applied to an analog-to-digital (A/D) converter 102. The illustrated A/D converter 102 samples the incoming composite video signal at four times the color subcarrier frequency (4fsc) and converts it into a digital signal at an output port 104. For a NTSC system, this results in 4 samples for one complete color-difference cycle and a total of 910 samples per horizontal line. The four samples may be represented by Y+I, Y+Q, Y−I, and Y−Q, where Y is luma, I is an in-phase component of chroma, and Q is a quadrature-phase component of chroma. Each sample includes Y and either I or Q, with I and Q alternating from sample-to-sample. Thus, one-half of one color-difference cycle includes one sample of I and one sample of Q, which together form a color-difference pair. For the detailed description of the exemplary embodiment, it is assumed that a picture element (hereinafter “pixel”) is one sample within one-half of a color-difference cycle. In alternative embodiments, a pixel may include both samples within one-half of one color difference cycle, two samples spanning adjacent halves, or essentially any number of such samples spanning essentially any number of color difference cycles. It is understood that pixels within a chroma signal are chroma pixels and pixels within a luma signal are luma pixels. In addition, although I and Q are used to describe the invention, those skilled in the art of video signal processing will find it readily apparent that essentially any two color difference signals may be used, e.g., conventional color difference signals such as R-Y, B-Y or other such signals representing color difference information.

The digital composite video signal at the output port 104 of the A/D converter 102 is applied to a separator circuit 106 for separating the composite video signal into its chroma and luma components. In the illustrated embodiment, the separator circuit 106 separates the composite video signal into an intermediate chroma signal (C′) and a luma signal Y. As described above, due to the overlap of luma and chroma components in the composite video signal at high frequencies, luma artifacts may be present in the C′ signal and chroma artifacts may be present in the Y signal after separation. In an exemplary embodiment, the separator circuit 106 is a conventional line-comb filter known to those of skill in the art of video signal processing.

The C′ signal is applied to processing circuitry 108. In a general overview, the processing circuitry 108 processes values obtained from the C′ signal for a reference chroma pixel and pixels to be displayed on a video display adjacent the reference chroma pixel to derive a scaling value. A scaling circuit 110 then scales the reference chroma pixel based on the scaling value for use in a replacement chroma signal, C. The values for the reference and adjacent pixels relate to choma components associated with the pixels (i.e., the color of the pixels). The reference chroma pixel is selectively scaled such that if the color associated with the reference chroma pixel is not similar to the color of any of the adjacent pixels, or is outside a predefined tolerance level, the reference chroma pixel is attenuated. For example, the reference chroma pixel may be attenuated in proportion to the difference in color between the reference chroma pixel and the adjacent pixel that is closest in color to the reference chroma pixel. Due to the bandwidth-limited nature of chroma signals within NTSC type systems, if the associated color of a reference chroma pixel is dissimilar to that of any adjacent pixel, it is likely that a luma artifact is present in the chroma signal for the reference chroma pixel. Accordingly, the reference chroma pixel is attenuated to reduce the effect of this luma artifact, thereby reducing cross-color distortion.

An exemplary embodiment of the processing circuitry 108 is now described in detail. The illustrated processing circuitry 108 includes a demodulator 116, a value circuit 118, a delay circuit 120, a difference circuit 122, a minimum value circuit 124, and a gain circuit 126. In an alternative exemplary embodiment, described in detail below, the processing circuitry 108 further includes a chroma artifact detector 128.

The demodulator 116 demodulates the C′ signal into first color difference components (e.g., I) and second color difference components (e.g., Q). The illustrated demodulator 116 receives the C′ signal at an input port 116a and produces a first color difference component at a first output port 116b and a second color difference component at a second output port 116c. The demodulator 116 is clocked at four times the color sub-carrier frequency, 4fsc, so that the color-difference components at the output ports 116b, 116c are updated on a pixel-by-pixel basis. Since, the chroma pixels alternately contain either an I component or a Q component, the demodulator 116 updates only the output port 116b or 116c associated with the chroma component at the input port 116a. For example, if a pixel containing an I component is present at the input port 116a, the demodulator 116 presents the I component at the first output port 116b and the Q component for an immediately preceding pixel at the second output port 116c. When the demodulator 116 receives the next pixel at the input port 116a, which will contain a Q component, the Q component at the second output port 116c is changed to match the received Q component and the I component at the first output port 116b remains unchanged. Thus, each pixel is associated with the component it contains and the component of an immediately preceding pixel. Those skilled in the art of video signal processing will recognize that the first and second color-difference components may represent luma that was not completely separated from the chroma by the separator circuit 106.

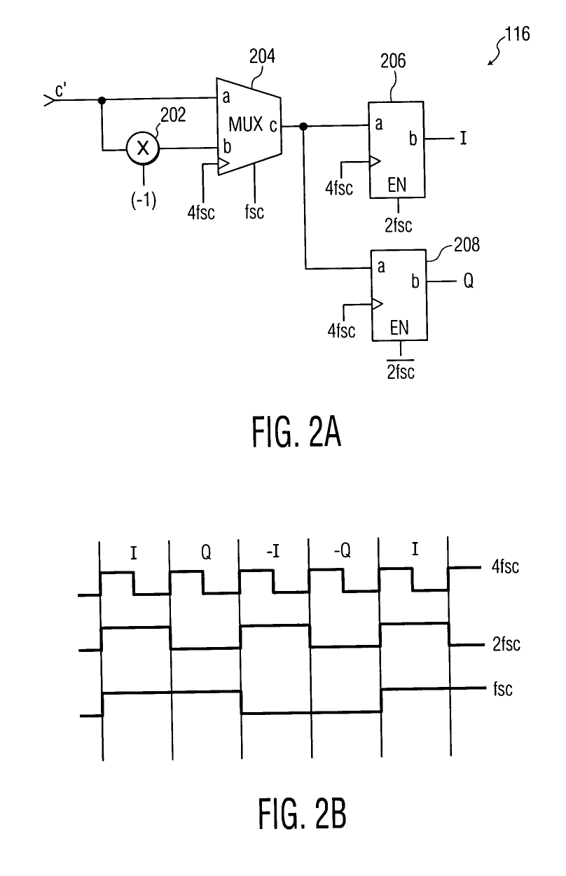

FIG. 2A depicts an exemplary demodulator 116 for use in the processing circuitry 108 (FIG. 1) and FIG. 2B depicts a timing diagram for use in describing the operation of the exemplary demodulator 116. The illustrated demodulator includes a multiplier 202, a multiplexer 204, a first register 206, and a second register 208, which operate at four times the color subcarrier frequency (4fsc). As described above, a complete color-difference cycle for a composite video signal sampled at 4fsc includes four samples that may be represented by Y+I, Y+Q, Y−I, and Y−Q, which repeat for each subsequent complete color-difference cycle. Thus, the C′ signal, which contains the chroma components of the composite video signal, may be represented by I, Q, −I, −Q, I, etc. (see FIG. 2B).

The multiplier 202 and the multiplexer 204 function together to rectify the C′ signal. The multiplier 202 multiplies the components of the C′ signal by a negative one (−1) to invert the components. The multiplexer 204 receives the C′ signal at a first port 204a and the C′ signal as inverted by the multiplier 202 at a second port 204b. The multiplexer 204 is switched based on fsc (see FIG. 2B). When fsc is high, the multiplexer 204 passes the components of the C′ signal and, when fsc is low, the multiplexer 204 passes the components of the C′ signal as inverted by the multiplier 202. Thus, the output port 204c of the multiplexer 204 passes a signal that may be represented by I, Q, I, Q, I, etc.

The signal at the output port 204c of the multiplexer 204 is applied to an input port 206a of the first register 206 and an input port 208a of the second register 208. The first and second registers 206, 208 are enabled by 2fsc (see FIG. 2B) at their respective enable ports (EN). When 2fsc is high, the first register 206 is enabled and passes the component value at the input port 206a to an output port 206b. When 2fsc is low, the second register 208 is enabled and passes the component value at the input port 208a to an output port 208b. The values produced at the output ports 206b, 208b of the corresponding register 206, 208 are maintained until the next time that register 206, 208 is enabled. Thus, I values are produced at the output port 206b of the first register 206 and Q values are produced at the output port 208b of the second register 208. Since, the I values are updated when 2fsc is high, the Q values are updated when 2fsc is low, and the I and Q values are maintained until the next time they are updated, the I and Q values produced by the demodulator circuit 116 represent a first color difference component, e.g., I (Q), of a sample and a second color difference component, e.g., Q (I), of an immediately preceding sample.

Referring back to FIG. 1, the value circuit 118 computes a value that represents the color difference component(s) associated with each chroma pixel (referred to herein as “chroma phase”). The term “chroma phase” is meant to represent essentially any value representing color that is associated with the chroma pixel. Thus, chroma phase may represent by way of non-limiting example the first color difference component and/or the second color difference component associated with a chroma pixel (e.g., I and/or Q), the first color difference component divided by the second color difference component, or other mathematical variations capable of representing color associated with a chroma pixel. In an exemplary embodiment, the chroma phase of a chroma pixel represents the inverse tangent of the first color difference component associated with that pixel divided by the second color difference component associated with that pixel.

The illustrated value circuit 118 derives the chroma phase using a divider circuit 130 and an inverse tangent circuit 132. The first and second color difference components are applied to the divider circuit 130, which divides the first color difference component (e.g., I) by the second color difference component (e.g., Q) to produce an intermediate value at an output port 130a. The intermediate value is then applied to the inverse tangent circuit 132, which processes the intermediate value to produced a chroma phase, a, for each chroma pixel. In an exemplary embodiment, the value circuit 118 is implemented in a known manner using a memory look-up table.

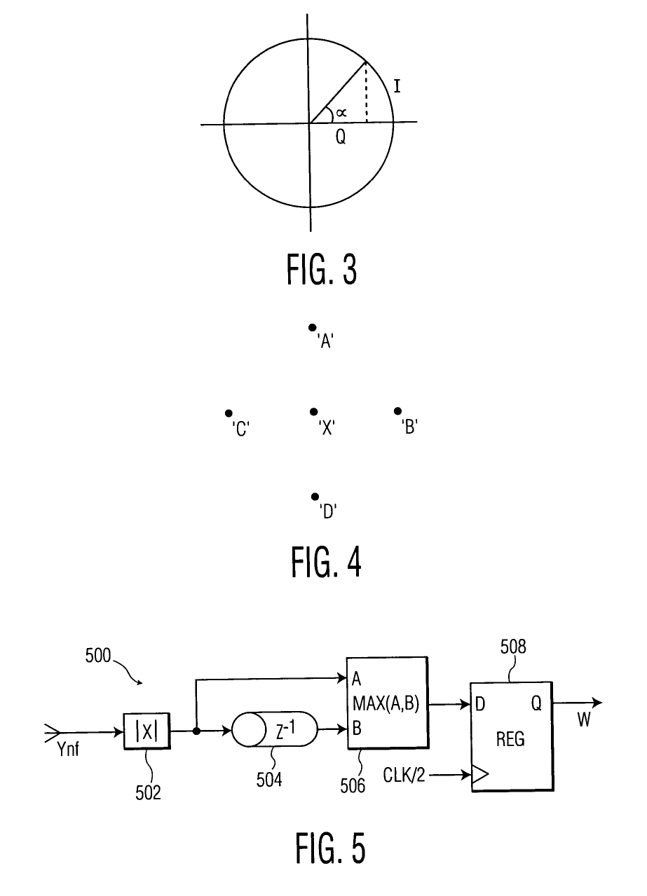

FIG. 3 is a graphical depiction of the chroma phase, α. If the first color-difference component (I) is on a vertical axis and the second color-difference component (Q) is on a horizontal axis, taking the inverse tangent of I/Q yields α. Each chroma phase represents a unique color for display on a video display with similar colors having similar chroma phases and different colors having different chroma phases. Larger chroma phase differences represent larger differences in color.

Referring back to FIG. 1, the delay circuit 120 introduces delay to pixels of the C′ signal such that chroma phases of a reference chroma pixel (herein referred to as ‘X’) and adjacent pixels (e.g., ‘A’, ‘B’, ‘C’, and ‘D’) are available concurrently. In an exemplary embodiment, the adjacent pixels include four pixels. As illustrated in FIG. 4, the four pixels include a pixel for display above ‘X’ (i.e., ‘A’), a pixel for display to the right of ‘X’ (i.e., ‘B’), a pixel for display to the left of ‘X’ (i.e., ‘C’), and a pixel for display below ‘X’ (i.e., ‘D’). In alternative embodiments, the adjacent pixels may include two or more pixels, e.g., pixels for display to the right and the left of ‘X’ (i.e., ‘B’, ‘C’), above and below ‘X’ (i.e., ‘A’, ‘D’), at diagonals to ‘X’, or combinations thereof. Those of skill in the art of video signal processing will recognize that, due to the bandwidth-limited nature of NTSC type systems, adjacent pixels for display to the right and to the left of ‘X’ tend to be more similar to ‘X’ than adjacent pixels for display above and below ‘X’. Thus, in an exemplary embodiment using only two adjacent pixels, adjacent pixels to the right and left of X are used.

As illustrated in FIG. 1, chroma phases for the reference chroma pixel and the adjacent pixels are produced by the delay circuit 120 using a first delay element 134, a second delay element 136, a third delay element 138, and a fourth delay element 140. As described above, an NTSC system has 910 samples per horizontal line. In order to produce the adjacent pixels above and below the reference pixel, in an NTSC system, a total delay of 1820 samples is needed. In the illustrated embodiment, the first and fourth delay elements 134, 140 are each 909 sample delay elements and the second and third sample delay elements 136, 138 are each one sample delay elements, which combined provide 1820 sample delays. With respect to ‘X’, the first and second delay elements 134, 136 delay ‘A’ a total of 910 samples so that ‘A’ and ‘X’ are concurrently available for comparison. With respect to ‘X’, the second delay element 136 delays ‘B’ for one sample so that ‘B’ and ‘X’ are concurrently available for comparison. With respect to ‘C’, the third delay element 138 delays ‘X’ for one sample so that ‘C’ and ‘X’ are concurrently available for comparison. With respect to ‘D’, the third and fourth delay elements 138, 140 delay ‘X’ a total of 910 samples so that ‘D’ and ‘X’ are concurrently available for comparison. In an exemplary embodiment, the first, second, third, and fourth delay elements 134, 136, 138, and 140 are implemented using one or more shift registers.

The difference circuit 122 determines variations between the chroma phase of the reference chroma pixel and chroma phases for each of the adjacent values presented by the delay circuit 120. For angular chroma phases, the difference circuit 122 produces values representing the angular difference between the chroma phase for the reference chroma pixel and the chroma phase of each of the adjacent pixels. The illustrated difference circuit 122 includes a first subtractor 142, a second subtractor 144, a third subtractor 146, and a fourth subtractor 148. The first subtractor 142 subtracts the chroma phase for the reference chroma pixel, ‘X’, from the chroma phase for the adjacent pixel above the reference chroma pixel, i.e., ‘A’. The second subtractor 144 subtracts the chroma phase for the reference chroma pixel, ‘X’, from the chroma phase for the adjacent pixel to the right of the reference chroma pixel, i.e., ‘B’. The third subtractor 146 subtracts the chroma phase for the reference chroma pixel, ‘X’, from the chroma phase for the adjacent pixel to the left of the reference chroma pixel, i.e., ‘C’. The fourth subtractor 148 subtracts the chroma phase for the reference chroma pixel, ‘X’, from the chroma phase for the adjacent pixel below the reference chroma pixel, i.e., ‘D’.

The minimum value circuit 124 selects the minimum variation determined by the difference circuit 122. In the illustrated embodiment, the minimum value circuit 124 receives at input ports 124a-d the determined variations between the reference chroma pixel and each of the adjacent pixels, e.g., pixels ‘A’, ‘B’, ‘C’, and ‘D’. The minimum value circuit 124 then produces at an output port 124e a representation of the determined variation that is the smallest. For example, if the variations represent angular chroma phases and the angular variations between ‘A’ and ‘X’ is 5 degrees, ‘B’ and ‘X’ is 4 degrees, ‘C’ and ‘X’ is 2 degrees, and ‘D’ and ‘X’ is 8 degrees, the minimum value circuit 124 produces a minimum variation value representing 2 degrees.

The gain circuit 126 processes the minimum variation value determined by the minimum value circuit 124 to produce a scaling value for selectively scaling the reference chroma pixel. In an exemplary embodiment, the gain circuit 126 produces a scaling value that is inversely proportional to the size of the minimum variation value. For example, a relatively small variation, e.g., less than one degree, results in a scaling value that would leave the reference chroma pixel essentially unchanged, i.e., a gain of one. A relatively large variation, e.g., greater than 16 degrees would result in the reference chroma pixel being completely attenuated, e.g., a gain of zero. If the reference chroma pixel is attenuated completely, thereby effectively removing it from the C′ signal, only the Y signal for that pixel is displayed. Hence, that pixel is displayed in monochrome. In one embodiment, the scaling value varies linearly from 1.0 to 0.0 for minimum variations between 0 and ±16 degrees. In this embodiment, if the minimum variation value represents zero degrees, indicating that the colors are substantially the same, the reference chroma pixel is not attenuated. If the variation value represents 16 degrees or more, the reference chroma pixel is attenuated completely. For variations between 0 and 16 degrees, the reference chroma pixel is scaled linearly. The selection of the range of angles involves a tradeoff between cross-color distortion and accurate color representation. For example, if the scaling value varies from 1.0 to 0.0 between 0 and 2 degrees, accurate colors may be discarded. If the scaling value varies between 0 and 45 degrees, however, the cross-color distortion may not be adequately reduced. Thus, system designers will select an appropriate range of scaling values and angular values. Also, the scaling value may vary between two non-zero angular difference values, e.g., between 2 and 10 degrees, with the scaling value being one below 2 degree and zero above 10 degrees. In addition, although the scaling value is described as a linear function, the scaling value may be stepped, exponential, or represent essentially any mathematical function.

The scaling circuit 110 scales the reference chroma pixel based on the scaling value determined by the gain circuit 126. In the illustrated embodiment, the scaling circuit receives the C′ signal at an input port 110a and the scaling values at a scaling port 110b. The scaling circuit 110 produces a scaled chroma signal, C, at an output port 10c based on the values at the input port 110a and the scaling port 110b. In an exemplary digital implementation, the scaling circuit 110 is a look-up table functioning as a multiplier and, in an exemplary analog implementation, the scaling circuit 110 is a conventional amplifier.

A first delay element 112 and a second delay element 114 are positioned between the separator circuit 106 and the input port 110a of the scaling circuit 110 to introduce delay such that at the scaling circuit 110 samples within the C′ signal correspond to the appropriate scaling value received from the gain circuit 126. In the illustrated embodiment, the first delay element 112 is a 910 sample delay element that compensates for the delay of the reference chroma pixel, which is introduced by the first and second delay elements 134, 136 of the delay circuit 120. The second delay element 114 is a compensating delay that compensates for delays introduced by the other components within the processing circuit 108.

In use, the Y/C separation apparatus 100 in accordance with the exemplary embodiment operates as follows. An A/D converter 102 samples the composite video signal to derive a digital composite video signal. The digital composite video signal is passed to a line-comb filter separator circuit 106 that separates the digital composite signal into an intermediate chroma signal, C′, and a luma signal Y. The C′ signal contains chroma components and, possibly, luma artifacts. A demodulator 116 demodulates the C′ signal into first and second color difference components (for descriptive purposes, I and Q). A value circuit 118 generates a chroma phase representing the colors associated with the I and Q values for each chroma pixel. The delay circuit 120 introduces delays so that the chroma phase of a reference chroma pixel can be compared to the chroma phases of the pixels that are adjacent to the reference chroma pixel. The difference circuit 122 determines the difference between the reference chroma pixel and each of the adjacent pixels and the minimum value circuit 124 selects the determined difference that is the smallest. The gain circuit 126 then generates a scaling value for scaling the reference chroma pixel based on the selected smallest determined difference. The scaling circuit then scales the reference chroma pixel within the C′ signal for use in the chroma signal, C. Larger chroma phase differences between the reference chroma pixel and the adjacent pixel that has the closest chroma phase to the reference chroma pixel results in greater attenuation of the reference chroma pixel while smaller chroma phase differences result in smaller attenuation. Thus, reference chroma pixels with larger chroma phase differences with respect to the adjacent pixel having the closest chroma phase (which is indicative of luma artifacts) are attenuated more than reference chroma pixels with smaller chroma phase differences, thereby reducing the affect of luma artifacts within the chroma to reduce cross-color distortion.

FIG. 1 is now used to describe an alternative exemplary embodiment of the Y/C separation apparatus 100. The alternative exemplary embodiment is similar to the exemplary embodiment described above with the exception that the processing circuitry 108 further includes a chroma artifact detector 128 which detects chroma artifacts in the luma signal, Y, for luma pixels corresponding to the reference pixels and the gain circuit 126 biases the scaling values based on the detected chroma artifacts. In the alternative exemplary embodiment, the Y signal is applied to the chroma artifact detector 128. The illustrated chroma artifact detector 128 determines a weight value, W, representing the relative weight of chroma artifacts within the Y signal. As is well known in the art of video signal processing, the presence of chroma artifacts in the luma signal is an indicator that luma artifacts are present in the chroma signal. Accordingly, if chroma artifacts are present in the Y signal, it is likely that luma artifacts are present in the C′ signal, with higher levels of chroma artifacts indicative of high levels of luma artifacts. Thus, as described in detail below, the weight value, W, is used to further refine the scaling value produced by the gain circuit 126 to compensate for cross-color distortion.

FIG. 5 depicts an exemplary artifact detection circuit 500 suitable for use as the chroma artifact detector 128 (FIG. 1). The illustrated artifact detection circuit 500 processes the Y signal to develop signals representing the relative weights, W, of the chroma artifacts for samples within the Y signal. The illustrated artifact detection circuit 500 includes an absolute value circuit 502, a delay element 504, a maximum circuit 506, and a register 508. At frequencies where the luma and chroma components overlap, e.g., greater than 3 MHz in a 6 MHz NTSC video channel, the chroma components are typically much larger than the luma components. Thus, if present, the chroma artifacts overpower the luma components within the Y signal at these frequencies. In certain exemplary embodiments, the Y signal includes only frequencies in which the luma and chroma components overlap since chroma artifacts are typically not of concern at non-overlapping frequencies. Those of skill in the art of video signal processing will find the production of such a Y signal readily apparent.

The absolute value circuit 502 rectifies the individual samples of the color-difference cycles within the Y signal since their arithmetic sign alternates from one-half color-difference cycle to the next. By rectifying the individual samples, the arithmetic sign is ignored, leaving the magnitude of individual sample intervals within the color-difference cycles.

The delay element 504 delays the rectified individual samples. The illustrated delay element 504 introduces a one-sample delay. Because the composite video signal is sampled at 4fsc, the individual samples for a Y signal containing chroma artifacts of I and Q alternate between having an I artifact and a Q artifact. When an I artifacts is at the input port of the delay element 504, a Q artifact is at the output port, and vice versa.

The maximum circuit 506 processes adjacent rectified individual samples. Therefore, if chroma artifacts containing I and Q artifacts are present, the maximum circuit 506 processes a Q artifact of a sample and an I artifact of an adjacent sample. Because rectifier 502 rectifies the samples, the maximum circuit 506 compares the magnitude of I and Q artifacts from adjacent individual samples within a single one-half color-difference cycle or spanning two one-half color-difference cycles. In the illustrated maximum circuit 506, the maximum circuit 506 produces a non-additive mix of the adjacent rectified individual sample intervals at an output port. Thus, if the I artifact is larger than the Q artifact, the magnitude of the I artifact is produced by the maximum circuit 506, and vice versa.

The register 508 processes the output signal of the maximum circuit 506. Preferably, the register 508 is clocked at one-half the individual sample rate. By clocking the register 508 at one-half the individual sample rate, the output signal produced by a color-difference pair (i.e., one I artifact and one Q artifact) is presented by the register 508 for two individual sample intervals. Thus, one value is produced for both the individual sample intervals of the color-difference pair. This value represents the relative weight, W, of the chroma artifacts within the line signal being processed, with larger W values representing higher levels of chroma artifacts within the luma.

Referring back to FIG. 1, the signals representing the relative weights, W, of the chroma artifacts within the Y signal are passed to the gain circuit 126. In the alternative exemplary embodiment, the illustrated gain circuit 126 generates a scaling value that is based on the weight value generated by the chroma artifact detector in addition to the minimum phase difference developed by the minimum value circuit 124 described above with reference to the exemplary embodiment.

The gain circuit 126 processes the minimum variation value determined by the minimum value circuit 124 and the weight value, W, determined by the chroma artifact detector 128 to produce a scaling value for scaling the reference chroma pixel. In accordance with an exemplary embodiment, the gain circuit 126 produces an intermediate scaling value that is inversely proportional to the size of the minimum variation value as described in detail above with reference to the exemplary embodiment. The intermediate scaling value is then modified based on the weight value, W. For large W values, the intermediate scaling value is modified to provide a scaling value that provides more scaling of the reference chroma pixel and for smaller W values, the intermediate scaling value is modified to provide a scaling value that provide less scaling of the reference chroma pixel.

In certain embodiments, if the W value is below a threshold value, indicating a low level of chroma artifacts in the Y signal and, therefore, a low level of luma artifacts in the C′ signal, the intermediate scaling value is discarded and the reference chroma pixel is not scaled. Thus, the reference chroma pixels for the C′ signal are only scaled in areas of the image that are likely to contain chroma artifacts, rather than in the entire image.

A first delay element 150 and a second delay element 152 are positioned in the Y signal path between the separator circuit 106 and the gain circuit 126 to introduce delay such that at the gain circuit 126 pixels within the C′ signal correspond to pixels within the Y signal. The illustrated first delay element 150 is a 910 sample delay element that compensates for delays introduced by the first and second delay elements 134, 136 of the delay circuit 120. The illustrated second delay element 152 is a compensating delay that compensates for delays introduced by other components within the processing circuitry 108.

While a particular embodiment of the present invention has been shown and described in detail, adaptations and modifications will be apparent to one skilled in the art. For example, although the detailed description describes the present invention in terms of an NTSC digital system, those of skill in the video signal processing art will appreciate that the invention may be practiced on either digital or analog representations of the composite video signal and with other well known video standards such as PAL and SECAM. Such adaptations and modifications of the invention may be made without departing from the scope thereof, as set forth in the following claims.

We claim:

1. A method for selectively scaling a chroma signal containing luma artifacts to reduce cross-color distortion, the chroma signal and a luma signal separated from a composite video signal, the method comprising the steps of:
processing a reference chroma phase associated with a reference chroma pixel and at least two adjacent chroma phases associated with at least two other pixels adjacent the reference chroma pixel to derive a scaling value, the scaling value based on chroma phase differences between the reference chroma pixel and at least one adjacent pixel; and
selectively scaling the reference chroma pixel based on the scaling value.

2. The method of claim 1, wherein the at least two other pixels include a first pixel for display above the reference chroma pixel, a second pixel for display below the reference chroma pixel, a third pixel for display to the right of the reference chroma pixel, and a fourth pixel for display to the left of the reference chroma pixel.

3. The method of claim 1, wherein the scaling value is based on a minimum difference between the chroma phase of the reference chroma pixel and the chroma phases of the at least two other pixels.

4. The method of claim 1;
wherein the composite video signal is an NTSC video signal sampled digitally to produce two samples per one-half color-difference cycle, each one-half color-difference cycle including either a first color difference component or a second color difference component;
wherein the reference chroma pixel and the at least two adjacent pixels each represent one sample of the one-half color-difference cycles;
wherein the chroma phases are inverse tangents of the first color difference components divided by the second color difference components; and
wherein first and second color difference components for the reference 11 chroma pixel are obtained from the reference chroma pixel and an adjacent reference chroma pixel immediately preceding the reference chroma pixel and first and second color difference components for the at least two adjacent pixels are obtained from each of the at least two adjacent pixels and corresponding pixels immediately preceding each of the at least two adjacent pixels.

5. The method of claim 1, wherein the processing step comprises at least the steps of:
determining chroma phase differences between the reference chroma pixel and each of the chroma phases of the at least two adjacent pixels; and
processing a minimum determined choma phase difference value to produce the scaling value, wherein the scaling value is inversely proportional to the minimum determined chroma phase difference value.

6. The method of claim 1, further comprising the step of:
detecting chroma in the luma signal for a luma pixel corresponding to the reference chroma pixel;
wherein the processing step further includes biasing the derived scaling value based on the detected chroma.

7. A method for selectively scaling a chroma signal containing luma artifacts to reduce cross-color distortion, the chroma signal and a luma signal separated from a composite video signal, the method comprising the steps of:
processing chroma information within the chroma signal associated with a reference chroma pixel to derive a reference chroma phase;
processing a plurality of pixels adjacent the reference chroma pixel to derive a plurality of chroma phases;
determining a minimum difference between the reference chroma phase and the plurality of chroma phases;
processing the minimum determined difference to produce a scaling value; and
selectively scaling the reference chroma pixel based on the scaling value.

8. The method of claim 7, wherein the plurality of pixels adjacent the reference chroma pixel include a first pixel for display above the reference chroma pixel, a second pixel for display below the reference chroma pixel, a third pixel for display to the right of the reference chroma pixel, and a fourth pixel for display to the left of the reference chroma pixel.

9. The method of claim 7, further comprising the step of:
detecting chroma in the luma signal for a luma pixel corresponding to the reference chroma pixel;
wherein the step of processing the minimum determined difference to produce the scaling value further includes biasing the scaling value based on the detected chroma to produce the scaling value.

10. An apparatus for processing a chroma signal containing luma artifacts to reduce cross-color distortion, the chroma signal and a luma signal separated from a composite video signal, the apparatus comprising:
a demodulator that demodulates the chroma signal into a first color difference component and a second color difference component;
a first processor that processes the first and second color difference components to derive an inverse tangent of the first color difference component divided by the second color difference component for values of the first and second color difference components associated with each of a plurality of chroma pixels;
a difference circuit that determines differences between an inverse tangent of a reference chroma pixel and inverse tangents of at least two pixels adjacent the reference chroma pixel;
a second processor that computes a scaling value based on a minimum determined difference determined by the difference circuit; and
a scaling circuit that selectively scales the reference chroma pixel by the computed scaling value.

11. The apparatus of claim 10, further comprising:
a plurality of delays coupled between the first computational circuit and the comparing circuit, the plurality of delays receiving the inverse tangents for the plurality of chroma pixels of the chroma signal and producing the inverse tangent for the reference chroma pixel and the inverse tangents for the at least two adjacent pixel to the comparing circuit concurrently.

12. The apparatus of claim 11, further comprising:
a chroma artifact detector that detects chroma artifacts in the luma signal for a luma pixel corresponding to the reference chroma pixel;
wherein the second processor biases the computed scaling value based on the detected chroma artifacts in the luma signal for the luma pixel corresponding to the reference chroma pixel.

13. An apparatus for processing a chroma signal containing luma artifacts to reduce cross-color distortion, the chroma signal and a luma signal separated from a composite video signal, the apparatus comprising:
a processor that processes a reference chroma phase associated with a reference chroma pixel and at least two adjacent chroma phases associated with each of at least two other pixels adjacent the reference chroma pixel to derive a scaling value for the reference chroma pixel, the scaling value based on chroma phase differences between the reference chroma pixel and at least one adjacent pixel; and
a scaling circuit that selectively scales the reference chroma pixel by 11 the scaling value.

14 The apparatus of claim 13, wherein the at least two other pixels include a first pixel for display above the reference chroma pixel, a second pixel for display below the reference chroma pixel, a third pixel for display to the right of the reference chroma pixel, and a fourth pixel for display to the left of the reference chroma pixel.

15. The apparatus of claim 13, wherein the processor comprises at least:
a difference circuit that determines a minimum variation between the reference chroma phase and the at least two adjacent chroma phases; and
a gain circuit that develops a scaling value based on the minimum determined variation.

16. The apparatus of claim 13, further comprising:
a chroma artifact detector that detects chroma artifacts in the luma signal for a luma pixel corresponding to the reference chroma pixel;
wherein the processor biases the derived scaling value based on the detected chroma artifacts in the luma signal for the luma pixel corresponding to the reference chroma pixel.

17. A system for selectively scaling a chroma signal containing luma artifacts to reduce cross-color distortion, the chroma signal and a luma signal separated from a composite video signal, the system comprising:
means for processing a reference chroma phase associated with a reference chroma pixel and at least two adjacent chroma phases associated with at least two other pixels adjacent the reference chroma pixel to derive a scaling value for the reference chroma pixel, the scaling value based on chroma phase differences between the reference chroma pixel and at least one adjacent pixel; and
means for selectively scaling the reference chroma pixel based on the scaling value.

18. The system of claim 17, wherein the processing means comprises at least:
means for determining a minimum chroma phase difference between the reference chroma pixel and the chroma phases of the at least two adjacent pixels; and
means for processing the minimum determined choma phase difference to produce the scaling value, wherein the scaling value is inversely proportional to the minimum determined chroma phase difference.

19. The system of claim 17, further comprising:
means for detecting chroma in the luma signal for a luma pixel corresponding to the reference chroma pixel;
wherein the scaling value is biased based on the detected chroma.

20. The system of claim 17, wherein the at least two other pixels include a first pixel for display above the reference chroma pixel, a second pixel for display below the reference chroma pixel, a third pixel for display to the right of the reference chroma pixel, and a fourth pixel for display to the left of the reference chroma pixel.
